(19) United States
(12) Patent Application Publication
(10) Pub. No.: US 2015/0065001 A1
(43) Pub. Date: Mar. 5, 2015

(54) SURFACE COATINGS

(71) Applicants: Stephen Richard COULSON, Abingdon (GB); Paul DE BLAQUIERE, Reading (GB); Delwyn EVANS, Reading (GB); Warren LEE, Harwell (GB)

(72) Inventors: Stephen Richard COULSON, Abingdon (GB); Paul DE BLAQUIERE, Reading (GB); Delwyn EVANS, Reading (GB); Warren LEE, Harwell (GB)

(21) Appl. No.: 14/511,784

(22) Filed: Oct. 10, 2014

Related U.S. Application Data
(63) Continuation of application No. 14/233,416, now abandoned.

(30) Foreign Application Priority Data
Jul. 21, 2011 (GB) 1112516.8

(51) Int. Cl. C09D 133/16; B05D 1/00

(52) U.S. Cl. CPC C09D 133/16; B05D 1/62
USPC 442/59; 428/523; 427/488

(57) ABSTRACT

A method of forming a liquid repellent coating on a surface of a substrate, where the surface is exposed to a monomer in a plasma process under conditions that maintain the monomer in situ for a period of time to allow a polymeric layer to form on the surface, wherein the conditions comprise at least one cycle of varying pressure.

The present invention relates to the coating of surfaces, in particular to the production of oil and water repellent surfaces, as well as to coated articles obtained thereby.

It is known to apply water and oil repellent coatings by a wide variety of methods. Such coatings typically include fluorocarbon chains, with the degree of oil and water repellency being a function of the number and length of fluorocarbon groups or moieties that can be fitted into the available space.

Plasma deposition techniques have been quite widely used for the deposition of polymeric coatings onto a range of surfaces. This technique is recognised as being a clean, dry technique that generates little waste compared to conventional wet chemical methods. Using this method, plasmas are generated from small organic molecules, which are subjected to an ionising electrical field under low pressure conditions. When this is done in the presence of a substrate, the ions, radicals and excited molecules of the monomer in the plasma polymerise in the gas phase and react with a growing polymer film on the substrate. Conventional polymer synthesis tends to produce structures containing repeat units which bear a strong resemblance to the monomer species, whereas a polymer network, generated using a plasma can be extremely complex.

U.S. Pat. No. 6,551,950 discloses use of plasma polymerisation to form an oil or water repellent surface using long chain hydrocarbons and fluorocarbons.

The applicants have discovered that by increasing the residency time of the monomer in the processing chamber, the quality of the coating and efficiency of its deposition can be increased.

Residency time is the average amount of time that a particle spends in a particular system. Residency time can be defined by the equation

τ=C/Q [1]

where τ is residence time, C is the capacity of the processing chamber and Q is the flow rate of the gas through the system at the pressure in the chamber.

From the above equation, it can be seen that for any given gas flow rate, an increase chamber size results in a longer residency time. Likewise, the slower the gas flow rate, the greater the residency time. Therefore, slow flow rates and large chambers will result in long residency times.

The longer a molecule remains in the processing chamber, the great the likelihood that it will undergo a deposition process, such as polymerisation, and attach to the surface.

A first aspect of the present invention provides a method of forming a liquid repellent coating on a surface of a substrate, said method comprising exposing said surface to a monomer in a plasma deposition process under conditions that maintain the monomer in situ for a period of time to allow a polymeric layer to form on the surface, wherein the conditions comprise at least one cycle of varying pressure.

The use of variable pressure cycling increases the residency time during which molecules of the monomer are prevalent in the processing chamber. This is due to the cycling keeping the pressure within the optimal range. It is desirable that the chamber remains within the optimal pressure range to maximise polymerisation.

In comparison to coating at static pressure, the use of variable pressure cycling improves the evenness of the coating, reduces the processing time and uses less monomer to produce a given thickness of coating.

The processing chamber may be provided with valve such as a gas exhaust gate, which is closed during introduction of the monomer. The exhaust gate may be adjusted to open, closed or partially open.

The at least one cycle may comprise continually introducing the monomer into the processing chamber (for example by injection) and allowing the pressure to rise. Exhaust gas may be expelled from the processing chamber at the end of each cycle.

The processing chamber may be at least partly evacuated at the beginning of each cycle; this enables it to reach the low pressure optimal for the polymer coating to form.

As gases are expelled at the end of each cycle, waste gases such as water vapour can be vented without affecting the low pressure achieved at the beginning of the cycle.

Whilst leaving the exhaust gate of the chamber closed throughout the process ensures that optimum pressure can easily be reached, a combination of monomer input and outgassing from the treated product causes the pressure within the chamber to build up until it exceeds optimum levels. By contrast, if the gate remains open for the duration of the process, outgassing products can be effectively removed; this allows the pressure to be brought down to optimum levels. However, a significant amount of the input monomer will simply flow through the chamber without undergoing polymerisation. The use of variable pressure cycling enables undesired outgassing products to be vented from the chamber but following venting the gate is closed to bring the chamber back to the bottom of the optimal pressure range. The closing of the gate at a particular point in the cycle is important to maintain the monomer in situ (increase its residency time) so polymerisation can occur.

The at least one cycle of varying pressure may comprise a time based cycle. For example the processing chamber may be at least partly evacuated after a predetermined amount of time in each cycle. Time cycling is particularly beneficial in that it allows for the monomer to be retained in situ so increasing residency time which assists in improving the coating process.

The at least one cycle of varying pressure may comprise a pressure based cycle. For example the processing chamber may be at least partly evacuated if the pressure falls outside the optimum range. The processing chamber may comprise pressure sensors to determine the pressure within the chamber. Feedback from the pressure sensor may be used to adjust an exhaust gate of the processing chamber. For example, the exhaust gate may be closed if the pressure drops below the optimum range and the exhaust gate may be opened if the pressure rises above the optimum range.

A pressure based system is suitable for low outgassing products, such as hearing aids and mobile telephones, as it produces a long cycle within the desired pressure range. For higher outgassing products, such as shoes, pressure based cycles can be too short. However, a time based cycle can be designed which allows the cycle to be of good length, gives the monomer a good residency time, whilst still staying near the optimal pressure.

The variable pressure may be maintained below a maximum pressure. For example, the maximum pressure may be at or below 150 mTorr. Suitably, the maximum pressure may be at or below 125 mTorr.

Each cycle may be between 45 and 75 seconds. Each cycle may be approximately 60 seconds.

The method may comprise exposing the surface to two or more cycles of varying pressure and in particular up to four cycles. Said two or more cycles may comprise between 5 and 12 cycles. Alternatively, said two or more cycles may comprise 8 or 9 cycles.

In one embodiment, the deposition process is a gas process. The deposition process may be a plasma process, for example a plasma polymerisation process.

Where the deposition process is a plasma polymerisation process, the coating may be applied using a pulsed plasma.

The liquid repellent coating may comprise an oil or water repellent coating.

The polymeric layer may be uniform. However, it may also be advantageous to form a non uniform polymeric layer, for example where the coating is used in a bio array.

The liquid repellent coating is suitable for surfaces on a wide range of substrates, for example fabric, metal, glass, ceramics, paper or polymer substrates. Items such as clothing (including footwear), laboratory consumables (including pipette tips), filtration membranes, electronic devices (including mobile phones, audio equipments, laptop computers and hearing aids), microfluidic devices and photovoltaic modules (such as solar panels) can all suitably be treated using the method of this invention.

Plasma polymers are typically generated by subjecting a coating forming precursor to an ionising electric field under low pressure conditions. Deposition occurs when excited species generated by the action of the electric field upon the precursor (radicals, ions, excited molecules etc) polymerise in the gas phase and react with the substrate surface to form a growing polymer film.

Suitable plasmas for use in the method described herein include non-equilibrium plasmas such as those generated by radiofrequencies (RF), microwaves or direct current (DC). They may operate at atmospheric or sub-atmospheric pressures as are known in the art. In particular however, they are generated by radiofrequencies (RF).

Various forms of equipment may be used to generate gaseous plasmas. Generally these comprise containers or plasma chambers in which plasmas may be generated. Particular examples of such equipment are described for instance in WO2005/089961 and WO02/28548, but many other conventional plasma generating apparatus are available.

In general, the item to be treated is placed within a plasma chamber together with the material to be deposited in gaseous state, a glow discharge is ignited within the chamber and a suitable voltage is applied, which may be pulsed.

The gas used within the plasma may comprise a vapour of the monomeric compound alone, but it may be combined with a carrier gas, in particular, an inert gas such as helium or argon. In particular helium is a preferred carrier gas as this can minimise fragmentation of the monomer.

When used as a mixture, the relative amount of the monomer vapour to carrier gas is suitably determined in accordance with procedures which are conventional in the art. The amount of monomer added will depend to some extent on the nature of the particular monomer being used, the nature of the substrate being treated, the size of the plasma chamber etc. Generally, in the case of conventional chambers, monomer is delivered in an amount of from 50-600 mg/min, for example at a rate of from 100-150 mg/min. Carrier gas such as helium is suitably administered at a constant rate for example at a rate of from 5-90, for example from 15-30 sccm. In some instances, the ratio of monomer to carrier gas will be in the range of from 100:1 to 1:100, for instance in the range of from 10:1 to 1:100, and in particular about 1:1 to 1:10. The precise ratio selected will be so as to ensure that the flow rate required by the process is achieved.

In some cases, a preliminary continuous power plasma may be struck for example for from 0.5-10 minutes for instance for about 4 minutes, within the chamber. This may act as a surface pre-treatment step, ensuring that the monomer attaches itself readily to the surface, so that as polymerisation occurs, the coating “grows” on the surface. The pre-treatment step may be conducted before monomer is introduced into the chamber, in the presence of only the inert gas.

The plasma is then suitably switched to a pulsed plasma to allow polymerisation to proceed, at least when the monomer is present.

In all cases, a glow discharge is suitably ignited by applying a high frequency voltage, for example at 13.56 MHz. This is suitably applied using electrodes, which may be internal or external to the chamber, but in the case of the larger chambers are internal.

Suitably the gas, vapour or gas mixture is supplied at a rate of at least 1 standard cubic centimetre per minute (sccm) and preferably in the range of from 1 to 100 sccm.

In the case of the monomer vapour, this is suitably supplied at a rate of from 80-300 mg/minute, for example at about 120 mg per minute depending upon the nature of the monomer, whilst the pulsed voltage is applied.

Gases or vapours may be drawn or pumped into the plasma region. In particular, where a plasma chamber is used, gases or vapours may be drawn into the chamber as a result of a reduction in the pressure within the chamber, caused by use of an evacuating pump, or they may be pumped or injected into the chamber as is common in liquid handling.

Polymerisation is suitably effected using vapours of compounds of formula (I), which are kept within a pressure range of from 40 to 150 mtorr, suitably at about 80-120 mtorr.

The applied fields are suitably of power of from 0.2 W to 20 W, more suitably about 2 W, applied as a pulsed field. These powers are suitable for use in a chamber having a volume of 50 cm³. For larger or smaller chambers, a suitable power giving the same power density can be used. For deposition of the polymeric layer, the pulses are applied in a sequence which yields very low average powers, suitably at a duty cycle of up to 10% (i.e. an on:off ratio of up to 10% on). More suitable, the duty cycle is from 0.1% to 1%. The on pulses can be long or short.

The fields are suitably applied from 30 seconds to 90 minutes, preferably from 5 to 60 minutes, depending upon the nature of the compound of formula (I) and the item being treated etc.

Suitably a plasma chamber used is of sufficient volume to accommodate multiple items.

A particularly suitable apparatus and method for producing items in accordance with the invention is described in WO2005/089961, the content of which is hereby incorporated by reference.

In particular, when using high volume chambers of this type, the plasma is created with a voltage as a pulsed field, at an average power of from 0.001 to 500 w/m³, for example at from 0.001 to 100 w/m³ and suitably for the functional layer, at from 0.005 to 0.5 w/m³.

These conditions are particularly suitable for depositing good quality uniform coatings, in large chambers, for example in chambers where the plasma zone has a volume of greater than 500 cm³, for instance 0.5 m³ or more, such as from 0.5 m³-10 m³ and suitably at about 1 m³. The layers formed in this way have good mechanical strength.

The dimensions of the chamber will be selected so as to accommodate the particular item being treated. For instance, generally cuboid chambers may be suitable for a wide range of applications, but if necessary, elongate or rectangular chambers may be constructed or indeed cylindrical, or of any other suitable shape.

The chamber may be a sealable container, to allow for batch processes, or it may comprise inlets and outlets for the items, for example yarn, to allow it to be utilised in a continuous process. In particular in the latter case, the pressure conditions necessary for creating a plasma discharge within the chamber are controlled using high volume pumps, as is conventional for example in a device with a “whistling leak”. However it will also be possible to process certain items at atmospheric pressure, or close to, negating the need for “whistling leaks”

The monomer may comprise a compound of formula (I)

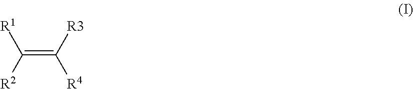

where R¹, R² and R³ are independently selected from hydrogen, alkyl, haloalkyl or aryl optionally substituted by halo; and R⁴ is a group X—R⁵ where R⁵ is an alkyl or haloalkyl group and X is a bond; a group of formula —C(O)O(CH₂)ₙY— where n is an integer of from 1 to 10 and Y is a bond or a sulphonamide group; or a group —(O)ₚR⁶(O)_{q}(CH₂)ₜ— where R⁶ is aryl optionally substituted by halo, p is 0 or 1, q is 0 or 1 and t is 0 or an integer of from 1 to 10, provided that where q is 1, t is other than 0.

The monomers used are selected from monomers of formula (I) as defined above. Suitable haloalkyl groups for R¹, R², R³ and R⁵ are fluoroalkyl groups. The alkyl chains may be straight or branched and may include cyclic moieties.

For R⁵, the alkyl chains suitably comprise 2 or more carbon atoms, suitably from 2-20 carbon atoms and preferably from 6 to 12 carbon atoms.

For R¹, R² and R³, alkyl chains are generally preferred to have from 1 to 6 carbon atoms.

Preferably R⁵ is a haloalkyl, and more preferably a perhaloalkyl group, particularly a perfluoroalkyl group of formula CₘF₂ₘ₊₁ where m is an integer of 1 or more, suitably from 1-20, and preferably from 4-12 such as 4, 6 or 8.

Suitable alkyl groups for R¹, R² and R³ have from 1 to 6 carbon atoms.

In one embodiment, at least one of R¹, R² and R³ is hydrogen. In a particular embodiment R¹, R², R³ are all hydrogen. In yet a further embodiment however R³ is an alkyl group such as methyl or propyl.

Where X is a group —C(O)O(CH₂)ₙY—, n is an integer which provides a suitable spacer group. In particular, n is from 1 to 5, preferably about 2. Suitable sulphonamide groups for Y include those of formula —N(R⁷) SO₂⁻ where R⁷ is hydrogen or alkyl such as C₁₋₄alkyl, in particular methyl or ethyl.

In one embodiment, the compound of formula (I) is a compound of formula (II)

CH₂═CH—R⁵ (II)

where R⁵ is as defined above in relation to formula (I).

In compounds of formula (II), X in formula (I) is a bond.

However in a preferred embodiment, the compound of formula (I) is an acrylate of formula (III)

CH₂═CR⁷C(O)O(CH₂)ₙR⁵ (III)

where n and R⁵ as defined above in relation to formula (I) and R⁷ is hydrogen, C₁₋₁₀ alkyl, or C₁₋₁₀haloalkyl. In particular R⁷ is hydrogen or C₁₋₆alkyl such as methyl. A particular example of a compound of formula (III) is a compound of formula (IV)

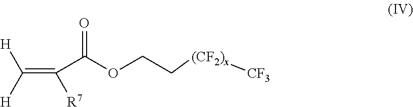

where R⁷ is as defined above, and in particular is hydrogen and x is an integer of from 1 to 9, for instance from 4 to 9, and preferably 7. In that case, the compound of formula (IV) is 1H,1H,2H,2H-heptadecafluorodecylacrylate.

In one embodiment, the compound of formula (IV) is a compound of formula (V)

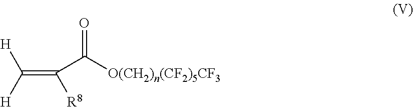

where R8 is hydrogen or methyl, ethyl or propyl group; and n=1 to 5.

A second aspect of the present invention provides a hydrophobic and/or oleophobic substrate which comprises a coating of a polymer which has been applied by the method.

The substrate may comprise, for example, a fabric or an item of clothing (including footwear) comprising said fabric. Additionally, the substrate may comprise an electronic device, microfluidic device, laboratory consumable or photovoltaic module.

Preferred features of the second aspect of the invention may be as described above in connection with the first aspect.

Throughout the description and claims of this specification, the words “comprise” and “contain” and variations of the words, for example “comprising” and “comprises”, mean “including but not limited to”, and do not exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Other features of the present invention will become apparent from the following example. Generally speaking the invention extends to any novel one, or any novel combination, of the features disclosed in this specification (including any accompanying claims and drawings). Thus features, integers, characteristics, compounds, chemical moieties or groups described in conjunction with a particular aspect, embodiment or example of the invention are to be understood to be applicable to any other aspect, embodiment or example described herein unless incompatible therewith.

Moreover unless stated otherwise, any feature disclosed herein may be replaced by an alternative feature serving the same or a similar purpose.

The invention will now be particularly described by way of example, with reference to the accompanying diagrammatic drawings in which:

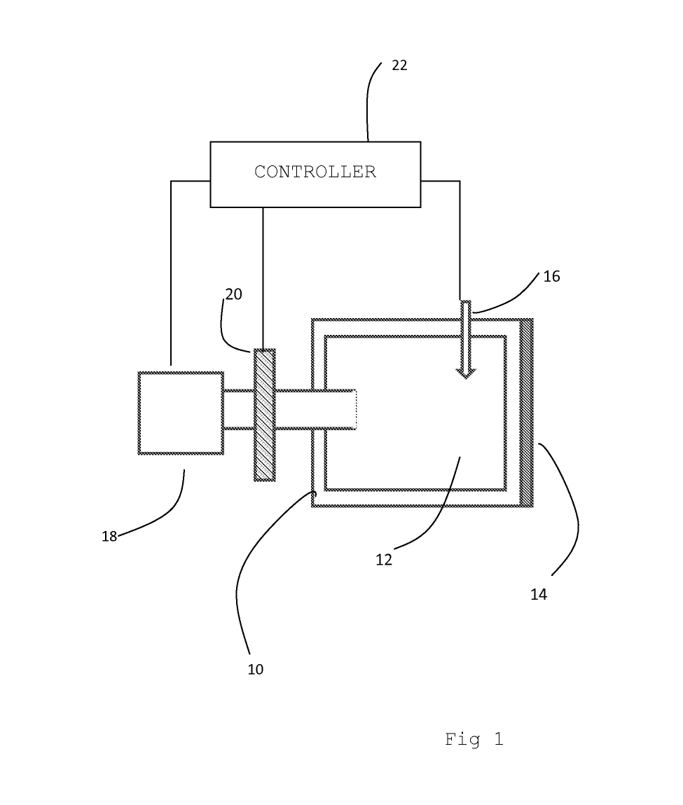

FIG. 1 illustrates the apparatus for carrying out the invention; and

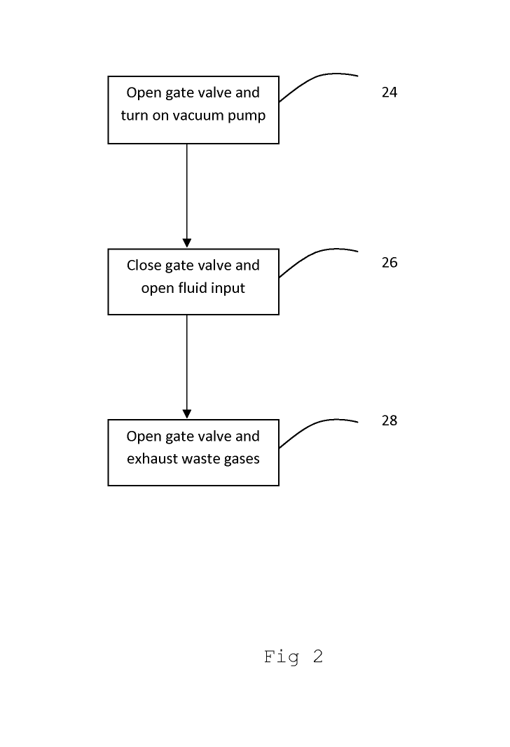

FIG. 2 is a flow diagram showing the events within each variable pressure cycle.

The apparatus used for forming the polymeric coating is shown in simplified from in FIG. 1. A processing chamber 10 has a processing area 12 within it and an access door 14. Equipment for generating a plasma within the processing chamber are not shown.

A fluid input 16 is provided to allow monomer to be introduced into the chamber. Other fluids may also be introduced via this fluid input, for example a carrier gas or a pre-treatment gas.

The processing chamber 10 is connected to a vacuum pump 18 via a gate valve 20. The gate valve 20 can be closed or opened (either partially or fully). When opened, the gate valve allows waste gases to be exhausted and when used in conjunction with the vacuum pump enables the pressure within the processing area reduced.

The apparatus also has a controller 22 which controls the fluid input, gate valve and vacuum pump. The controller may be a microprocessor, PC or any other suitable device.

FIG. 2 shows the sequence of events during a cycle. In a first step 24, the gate valve is opened and the vacuum pump partially evacuates the processing chamber. In particular the pressure in the processing chamber is brought down to a desired low pressure. The low pressure allows for increased residency time of monomer(s) in the processing chamber as it/they cannot escape from the valve and flow downstream with the evacuated gases. In a second step 26, the gate valve is closed (or at least partially closed) and the fluid input is opened, this allows the monomer to be introduced into the chamber. The pressure in the chamber gradually increases and in particular this is as a result of vaporisation of monomers introduced into the chamber. In a third step 28, the gate valve is opened so that the waste gases can be exhausted. The controller controls the actions of the vacuum pump, gate valve and fluid input during these steps in each cycle. The cycle is repeated to maintain the desired residency time of the monomer. The cycling rate can be selected either by the time taken to reach a given pressure or by the duration that is needed to provide monomer conversion to polymer. A typical number of cycles that is used is four. Further the use of cycling allows for the deposition rate to be moved within the chamber so that there is more uniformity of coating. In particular the deposition is moved from the edges of the chamber to the centre to improve coating.

The cycles may be time based or pressure based. In the case of time based cycles, the controller further includes a clock or counter which is used to control the length of each cycle and the timing of the events in each cycle.

If a pressure based cycle is used, one or more pressure sensors are provided in the processing area, with pressure data being output to the controller. In this case, each step occurs when the pressure within the processing area reaches a pre-determined value.

### EXAMPLE 1

In a first example, a hearing aid was coated using a monomer of formula VI below.

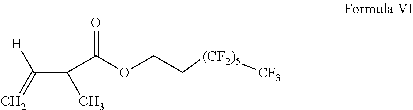

The plasma polymerisation coating was applied in an inductively coupled glow discharge reactor with a leak rate of better than 6×10⁻⁹ mol s⁻¹ and a monomer flow rate of 4 mg/min or 3.2 mol s⁻¹. This was connected to a two stage Edwards rotary pump via a liquid nitrogen cold trap, a thermocouple pressure gauge, and a monomer tube containing the monomer. A 13.56 MHz radio frequency (RF) generator was used to power the electrical discharge.

A hearing aid having a textured ABS plastic exterior surface was placed into the centre of the chamber, which was then evacuated down to 20 mTorr.

The glow discharge was ignited the chamber subjected to continuous wave (CW) of 150 W for 30 s, during which the monomer was injected into the chamber in two doses 3 seconds apart.

A pulsed wave (PW) was then applied at 450 W at a duty cycle of 35 microseconds on and 10 milliseconds off (0.35%), whilst the monomer was injected into the chamber; 140 shots with 3 seconds between each shot.

During the PW phase, the pressure within the chamber was cycled as follows: Once the chamber pressure reached 50 mTorr, the gate valve was closed for 60 seconds. After 60 seconds has elapsed, the gate was opened by a fixed percentage (between 50 to 100%). When pressure fell to 50 mTorr, the gate was again closed for 60 seconds and the cycle repeated. This was repeated for the duration of the PW cycle (i.e. approximately 420 seconds).

This method was repeated without pressure cycling. The conditions were exactly the same as above, except that the gate valve is left open for the duration of the continuous wave phase and PW phase.

The effect of the plasma deposition on the surface energy of the treated substrate was then determined. Water was applied to the surface of the treated hearing aid and the contact angle measured. The tests were carried out on the coated hearing aid surface and also after the coating had been subjected to 1,000 abrasions (using the same test as example 2). The results of coatings applied using pressure cycling and without pressure cycling are listed in the table below.

TABLE 1

| | | Contact angle after |
|---|---|---|
| | Initial contact | 1,000 abrasions |
| Conditions | angle (average) | (average) |
| With pressure | 108.98 | 110.28 |
| cycling | | |
| Without pressure | 103.63 | 99.03 |
| cycling | | |

As seen from table 1, higher contact angles are achieved with pressure cycling (both initially and after abrasions). This shows that the desired performance levels of the coating has been achieved more quickly with pressure cycling than without.

### EXAMPLE 2

In a second example, a mobile telephone was coated, which included various substrates of plastic, glass and metal. The same apparatus and monomer was used as described in example 1.

The chamber was evacuated to 20 mTorr before igniting the glow discharge and subjecting the chamber to continuous wave (CW) of 150 W for 30 s, during which the monomer was injected into the chamber in two doses 3 seconds apart.

A pulsed wave (PW) was then applied at 300 W at a duty cycle of 35 microseconds on and 10 milliseconds off (0.35%), whilst monomer was injected into the chamber; 140 shots with 3 seconds between each shot.

During the PW phase, the pressure within the chamber was cycled as follows: Once the chamber pressure reached 50 mTorr, the gate was closed for 60 seconds. After 60 seconds has elapsed, the gate was opened by a fixed percentage (between 50 to 100%). When pressure fell to 50 mTorr, the gate was gain closed for 60 seconds and the cycle repeated. This was repeated for the duration of the PW cycle (i.e. approximately 420 seconds).

This method was repeated without the pressure cycling.

The effect of the plasma deposition on the surface energy of the treated substrate was then determined. Water was applied to the surface of the treated hearing aid and the contact angle measured. The tests were carried out on the coated hearing aid surface and also after the coating had been subjected to 1,000 abrasions using the Taber 5750 linear abrader with a standard Martindate abrasion fabric, 500 g weight with a 1 inch abrasion path. The results of coatings applied using pressure cycling and without pressure cycling are listed in the table below.

TABLE 2

| | | Contact angle after |
|---|---|---|
| | Initial contact | 1,000 abrasions |
| Conditions | angle (average) | (average) |
| Untreated | 89.04 | 77.4125 |
| Without pressure | 91.78 | 113.3875 |
| cycling | | |
| With pressure | 115.15 | 114.2375 |
| cycling | | |

As with the previous example, the coating applied with pressure cycling results in a higher contact angle. The contact angle changes very little following the abrasions. As before, this is believed to be due to the coating forming more quickly.

### EXAMPLE 3

In a third example, a mobile telephone was coated, which included various substrates of plastic, glass and metal. The same apparatus and monomer was used as described in example 1.

The chamber was evacuated to 20 mTorr before igniting the glow discharge and subjecting the chamber to continuous wave (CW) of 150 W for 30 s, during which the monomer was injected into the chamber in one dose.

A pulsed wave (PW) was then applied at 450 W at a duty cycle of 35 microseconds on and 10 milliseconds off (0.35%), whilst monomer was injected into the chamber; 130 shots with 3 seconds between each shot.

During the PW phase, the pressure within the chamber was cycled by alternatively opening and closing the gate valve for periods of 60 seconds.

This method was repeated without the pressure cycling, during which the gate was left open for the duration of the CW and PW phases.

The effect of the plasma deposition on the surface energy of the treated substrate was then determined using the same methods outlined in example 2.

TABLE 3

| | Average contact | Average contact |
|---|---|---|
| Conditions | angle (interior) | angle (exterior) |
| Without pressure | 88.52 | 113.47 |
| cycling | | |
| With pressure | 113.62 | 121.42 |
| cycling | | |

Table 3 shows greatly increased deposition on the inside of the telephone where pressure cycling is used, as compared to no cycling.

As shown by the examples, the use of variable pressure cycling speeds up the process of achieving the performance levels desired, i.e. it speeds up the processing time.

As shown in example 3, not only is an improvement seen on the outside of products but also on the inside of complex products. To achieve the same results with a non-cycling process would require a longer processing time and more monomer (although the same performance level may still not be reached).

By speeding up the processing time, pressure cycling also has the effect of using less monomer. Other advantages include improved evenness of coating. In addition, the desired performance levels occur across the whole processing chamber.

The increase in residency time has additional advantages, for example improved penetration of the coatings into nooks and crannies, for example in electronic devices. In addition, the increased residency time enables coatings to be formed from monomers which do not polymerise well in conventional conditions, for example shorter chain monomers such as 1H,1H,2H,2H-tridecafluoro-octyl acrylate.

1. A method of forming a liquid repellent coating on a surface of a substrate, said method comprising exposing said surface to a monomer in a plasma deposition process under conditions that maintain the monomer in situ for a period of time to allow a polymeric layer to form on the surface, wherein the conditions comprise at least one cycle of varying pressure.

2. A method according to claim 1, wherein the substrate is exposed to a plasma in a processing chamber and the processing chamber is at least partly evacuated at the beginning of each cycle.

3. A method according to claim 1, wherein each cycle comprises continually introducing the monomer into a processing chamber and allowing the pressure to rise.

4. A method according to claim 2, wherein exhaust gas is expelled from the processing chamber at the end of each cycle.

5. A method according to claim 1, wherein a valve is used to control pressure in and out of the processing chamber, with the valve being used to increase residency time of the monomer in the chamber to allow the polymeric layer to form.

6. A method according to claim 1, wherein the maximum pressure is at or below 150 mTorr and more particularly is at or below 125 mTorr.

7. A method according to claim 1, wherein the at least one cycle of varying pressure may comprise a time based cycle and/or a pressure based cycle.

8. A method according to claim 1, wherein each cycle is between 45 and 75 seconds.

9. A method according to claim 1, wherein exposing the surface to at least one cycle of varying pressure comprises exposing the surface to two or more cycles of varying pressure and in particular said two or more cycles comprises between 5 and 12 cycles and more particularly 8 or 9 cycles.

10. A method according to claim 1, wherein the monomer is a compound of formula (I) 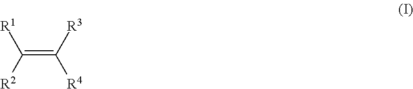
where R¹, R² and R³ are independently selected from hydrogen, alkyl, haloalkyl or aryl optionally substituted by halo; and R⁴ is a group X—R⁵ where R⁵ is an alkyl or haloalkyl group and X is a bond; a group of formula —C(O)O(CH₂)ₙY— where n is an integer of from 1 to 10 and Y is a bond or a sulphonamide group; or a group —(O)ₚR⁶(O)_{q}(CH₂)ₜ— where R⁶ is aryl optionally substituted by halo, p is 0 or 1, q is 0 or 1 and t is 0 or an integer of from 1 to 10, provided that where q is 1, t is other than 0.

11. A method according to claim 10 wherein the compound of formula (I) is a compound of formula (II) 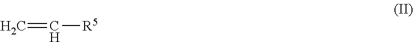
where R⁵ is as defined in claim 10, or a compound of formula (III)
H₂C═CR⁷C(O)O(CH₂)ₙR⁵ (III)
where n and R⁵ as defined in claim 10 and R⁷ is hydrogen, C₁₋₁₀ alkyl, or C₁₋₁₀ haloalkyl.

12. A method according to claim 11 wherein the compound of formula (III) is a compound of formula (IV) 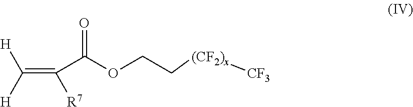
where R⁷ is as defined in claim 11, and x is an integer of from 1 to 9.

13. A method according to claim 12 wherein the compound of formula (IV) is 1H, 1H, 2H, 2H-heptadecafluorodecylacrylate, or a compound of formula (V) 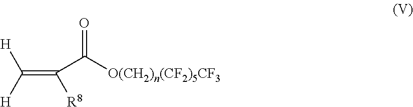
where R⁸ is hydrogen or methyl, ethyl or propyl; and n=1 to 5.

14. A method according to claim 1, wherein the plasma deposition process is a plasma polymerisation process and the coating is applied using a pulsed plasma.

15. A method according to claim 14, wherein the pulsing sequence comprises a ratio of on:off of 1:200 to 1:1500; and/or the pulsing sequence comprises power on for 20-50 μs and off for from 500 μs to 30000 μs.

16. A method according to claim 1, wherein the average power levels are between 1 W and 1 kW and more particularly between 300 W and 500 W.

17. A method according to claim 1, wherein in a preliminary step, a continuous power plasma is applied to the surface, optionally in the presence of an inert gas.

18. A method according to claim 1, wherein the liquid repellent coating comprises an oil or water repellent coating.

19. A liquid repellent substrate which comprises a coating of a polymer which has been applied by a method according to claim 1.

20. A substrate according to claim 19 which comprises a fabric and in particular an item of clothing.
